(19) United States
(12) Patent Application Publication
(10) Pub. No.: US 2002/0190825 A1
(43) Pub. Date: Dec. 19, 2002

(54) Spoolless coil assembly for vehicle solenoid valves

(76) Inventors: Brooks H. Danley, El Paso, TX (US); Duane Zedric Collins, El Paso, TX (US)

Correspondence Address: MARGARET A. DOBROWITSKY, DELPHI TECHNOLOGIES, INC., Legal Staff, P.O. Box 5052, Mail Code: 480-414-420, Troy, MI, 48007-5052, US

(21) Appl. No.: 09/882,238

(22) Filed: Jun. 15, 2001

(51) Int. Cl. H01F 3/00

(52) U.S. Cl. 335/256

(57) ABSTRACT

A spoolless coil assembly includes a heat conductive actuator tube that has a first end cap and a second end cap on its ends. A winding area around the actuator tube is established between the end caps, and a wire is wound around the actuator tube within the winding area to form a coil. Since the coil is wound directly to the actuator tube, heat generated by the coil is dissipated by the metal actuator tube. Thus, the efficiency of the coil is promoted.

### TECHNICAL FIELD

The present invention relates generally to coil assemblies for solenoid valves.

### BACKGROUND OF THE INVENTION

Modern motor vehicles are equipped with numerous fluid based systems that help enhance the safety and quality of the vehicle operation. Many of these systems include solenoid valves that control the flow of fluid through the different components of the system. These valves typically include a coil in a surrounding relationship with an actuator. When the coil is energized to create a magnetic field around the actuator, the magnetic field moves the actuator either from an open position to a closed position or from a closed position to an open position.

Thus, a normally open valve closes when the coil is energized and a normally closed valve opens when the coil is energized.

In either case, when the coil is energized it generates heat. Unfortunately, as recognized herein, the heat generated by the coil can be detrimental to the operation of the solenoid valve. For example, as the heat increases, the thermodynamic efficiency of the coil decreases and the power consumption of the solenoid valve also increases. Moreover, to withstand the high heat, other components within the solenoid valve must be made from relatively expensive materials.

As recognized by the present invention, the coil is typically wrapped around a plastic spool that, in turn, surrounds the actuator. Unfortunately, the plastic spool prevents the heat generated by the coil from quickly and easily dissipating. The present invention has recognized these prior art drawbacks, and has provided the below-disclosed solutions to one or more of the prior art deficiencies.

### SUMMARY OF THE INVENTION

A spoolless coil assembly includes a metal actuator tube and an actuator that is slidably disposed in the tube. A first end cap is engaged with a first end segment of the actuator tube and a second end cap is engaged with a second end segment of the actuator tube. The second end cap is distanced from the first end cap to establish a winding area between the end caps. Moreover, a wire is wound onto the metal actuator tube within the winding area to form a coil that is energizable to move the actuator.

In a preferred embodiment, the coil contacts the actuator tube along the length of the winding area. Preferably, a non-magnetic sleeve is disposed between the actuator and the actuator tube.

In another aspect of the present invention, a method for making a coil assembly includes providing an actuator tube and then, winding a wire around the actuator tube to form a coil.

In yet another aspect of the present invention, a spoolless coil assembly includes a heat conductive actuator tube and an actuator slidably disposed therein. A non-magnetic sleeve is disposed between the actuator and the actuator tube. A first end cap and a second end cap are installed around the actuator tube. The second end cap is distanced from the first end cap to establish a winding area around the actuator tube. In this aspect, a wire is wound around the actuator tube within the winding area to form a coil that substantially contacts the actuator tube along the length of the winding area. The coil is energizable to move the actuator.

In still another aspect of the present invention, a solenoid valve includes a coil of wire and an actuator slidably disposed within the coil. The actuator is moved when the coil is energized. This aspect of the present invention includes a heat dissipation means that is located between the coil and the actuator. The heat dissipation means abuts the coil for absorbing heat therefrom. Moreover, in this aspect, a magnetic shield means is disposed between the coil and the actuator.

The present invention will now be described, by way of example, with reference to the accompanying drawings, in which:

### BRIEF DESCRIPTION OF THE DRAWINGS

FIG. 1 is side plan view of the spoolless coil assembly with portions shown in phantom; and

FIG. 2 is a top plan view of the spoolless coil assembly.

### DESCRIPTION OF AN EMBODIMENT OF THE INVENTION

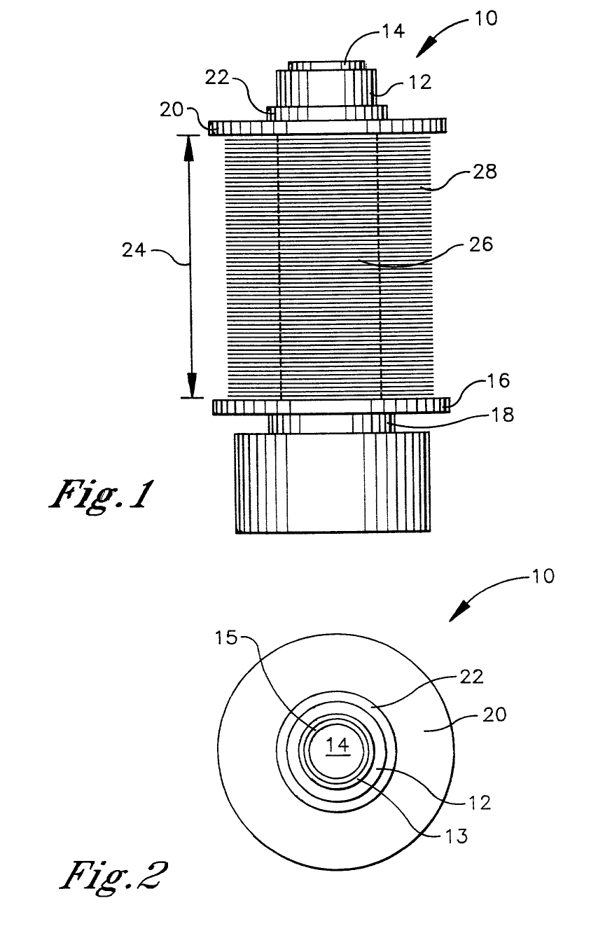

Referring to FIGS. 1 and 2, a spoolless coil assembly is shown and generally designated 10. FIGS. 1 and 2 show that the coil assembly includes a preferably heat conductive actuator tube 12 in which an actuator 14 is slidably disposed. To prevent magnetic lock-up between the actuator tube 12 and the actuator 14, a non-magnetic sleeve 13 is installed between the actuator tube 12 and the actuator 14. Moreover, an air gap 15 is established between the sleeve 13 and the actuator 14.

As also shown, the coil assembly 10 includes a generally disk-shaped first end cap 16. The first end cap 16 is formed with a central bore (not shown) that is sized to allow the end cap 16 to be fitted over the actuator tube 12. In a preferred embodiment, the end cap 16 is press fitted around the actuator tube 12.

FIG. 1 shows that the first end cap 16 includes a hub 18. It is to be appreciated that the hub 18 circumscribes the central bore of the end cap 16. When the first end cap 16 is installed around the actuator tube 12, the hub 18 increases the contact area between the end cap 16 and the actuator tube 12.

FIG. 1 further shows that the coil assembly 10 includes a second end cap 20 that is formed with a central bore (not shown) that is sized to allow the second end cap 20 to be preferably press fitted around the actuator tube 12. The second end cap 20 also includes a hub 22 that circumscribes the central bore formed in the second cap 20. FIG. 1 shows that the first end cap 16 and the second end cap 20 are installed on the actuator tube 12 at a distance 24 from each other so that a winding area 26 is established between the end caps 20, 22.

As shown in FIG. 1, a wire is wound directly on the actuator tube 12 between the end caps 16, 20, i.e., within the winding area 26, to form a coil 28. When the coil 28 is energized, it causes the actuator 14 to move within the actuator tube 12. Since the coil 28 is wound directly onto the metal actuator tube 12, heat generated by the coil 28 is dissipated through the metal actuator tube 12.

With the configuration of structure described above, it is to be appreciated that the spoolless coil assembly 10 provides a means by which heat generated by the coil 28 can be dissipated. Thus, the efficiency of the coil 28 is promoted.

While the particular SPOOLLESS COIL ASSEMBLY FOR VEHICLE SOLENOID VALVES as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

1. A spoolless coil assembly, comprising:
a metal actuator tube;
an actuator slidably disposed in the tube;
a first end cap engaged with a first end segment of the actuator tube;
a second end cap engaged with a second end segment of the actuator tube, the second end cap being distanced from the first end cap to establish a winding area between the end caps; and
a wire wound onto the metal actuator tube at least partially within the winding area to form a coil energizable to move the actuator.

2. The coil assembly of claim 1, wherein the coil contacts the actuator tube substantially along the length of the winding area.

3. The coil assembly of claim 2, further comprising a non-magnetic sleeve disposed between the actuator and the actuator tube.

4. A method for making a coil assembly, comprising the acts of:
providing an actuator tube; and
winding a wire around the actuator tube to form a coil.

5. The method of claim 4, further comprising the acts of: disposing a first end cap around the actuator tube;
disposing a second end cap around the actuator tube such that a winding area is established around the actuator tube between the end caps; and
winding the wire around the actuator tube within the winding area to form the coil.

6. The method of claim 5, further comprising the act of:
disposing an actuator within the actuator tube, actuator tube being slidable relative to the actuator tube.

7. The method of claim 6, further comprising the act of:
disposing a sleeve between the actuator and the actuator tube.

8. A spoolless coil assembly, comprising:
a heat conductive actuator tube;
an actuator slidably disposed within the actuator tube;
a non-magnetic sleeve disposed between the actuator and the actuator tube;
a first end cap installed around the actuator tube;
a second end cap installed around the actuator tube, the second end cap being distanced from the first end cap to establish a winding area around the actuator tube;
a wire wound around the actuator tube within the winding area to form a coil that substantially contacts the actuator tube along the length of the winding area, the coil being energizable to move the actuator.

9. A solenoid valve, comprising:
a coil of wire;
an actuator slidably disposed within the coil for movement of the actuator when the coil is energized;
heat dissipation means located between the coil and actuator and abutting the coil for absorbing heat therefrom; and
magnetic shield means disposed between the coil and actuator.
